(19) United States
(12) Patent Application Publication
(10) Pub. No.: US 2024/0205372 A1
(43) Pub. Date: Jun. 20, 2024

(54) METHODS, SYSTEMS, ARTICLES OF MANUFACTURE AND APPARATUS TO MANAGE VIDEO CONFERENCING CALL DATA

(71) Applicant: Intel Corporation, Santa Clara, CA (US)

(72) Inventors: Praveen Kashyap Ananta Bhat, Bangalore (IN); Rahul R., Aluva (IN); Passant V. Karunaratne, Chandler, AZ (US); Navya P., Bangalore (IN); Nagalakshmi Shashidhara Guptha, Bengaluru (IN); Venkateshan Udhayan, Portland, OR (US); Tao Tao, Portland, OR (US); Chia-Hung S. Kuo, Folsom, CA (US); Balvinder Pal Singh, Bhilai (IN); Stanley Baran, Chandler, AZ (US); Aiswarya Pious, Bangalore (IN); Michael Rosenzweig, Queen Creek, AZ (US)

(21) Appl. No.: 18/590,505

(22) Filed: Feb. 28, 2024

(51) Int. Cl. H04N 7/15; H04W 24/08

(52) U.S. Cl. CPC H04N 7/157; H04W 24/08

(57) ABSTRACT

Systems, apparatus, articles of manufacture, and methods are disclosed to manage video conferencing call data. An example apparatus comprises interface circuitry, machine-readable instructions, and at least one processor circuit to be programmed by the machine-readable instructions to access input data associated with a first video conferencing device, the first video conferencing device communicatively coupled to a second video conferencing device via a network, generate a representation of the input data when a performance metric corresponding to the network satisfies a threshold value, and transmit the representation to the second video conferencing device via the network.

### FIELD OF THE DISCLOSURE

This disclosure relates generally to video conferencing and, more particularly, to methods, systems, articles of manufacture and apparatus to manage video conferencing call data.

### BACKGROUND

Video conferencing platforms are indispensable tools for collaboration in most industrial, commercial, academic, and governmental environments. In video conferencing, audio and visual telecommunications technologies are utilized in a collaborative manner to provide communication between users at different sites (e.g., via a network).

### BRIEF DESCRIPTION OF THE DRAWINGS

FIG. 1 is a block diagram of an example environment in which example call maintenance circuitry and/or example avatar controller circuitry operates to manage video conferencing call data.

FIG. 2 is an example schematic diagram illustrating an implementation of the example call maintenance circuitry and/or the example avatar controller circuitry of FIG. 1.

FIGS. 3A-3F illustrate example image recognition techniques for use with examples disclosed herein.

FIG. 4 is a flowchart representative of example machine readable instructions and/or example operations that may be executed, instantiated, and/or performed by example programmable circuitry to implement the example call maintenance circuitry of FIG. 1.

FIG. 5 is a flowchart representative of example machine readable instructions and/or example operations that may be executed, instantiated, and/or performed by example programmable circuitry to implement the example avatar controller circuitry of FIG. 1.

FIG. 6 is a block diagram of an example processing platform including programmable circuitry structured to execute, instantiate, and/or perform the example machine readable instructions and/or perform the example operations of FIGS. 4 and 5 to implement the example call maintenance circuitry and/or the example avatar controller circuitry of FIG. 1.

FIG. 7 is a block diagram of an example implementation of the programmable circuitry of FIG. 6.

FIG. 8 is a block diagram of another example implementation of the programmable circuitry of FIG. 6.

FIG. 9 is a block diagram of an example software/firmware/instructions distribution platform (e.g., one or more servers) to distribute software, instructions, and/or firmware (e.g., corresponding to the example machine readable instructions of FIGS. 4 and 5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

As the prevalence of mobile devices and social networking continues to grow, an increasing number of users seek to communicate with others via mixed media (e.g., video, audio/video (AV)) as an alternative to typical phone calls and text-based messages. However, existing AV conferencing programs (e.g., Microsoft Teams) face a number of limitations. For example, intermittent network connectivity and/or insufficient network conditions (e.g., low bandwidth, network noise, etc.) associated with a network may cause video and/or audio quality degradation in an AV conferencing call. Even sporadic discontinuities in network connectivity and/or signal strength may negatively impact the user experience with AV conferencing devices. In some examples, a user of an example video conferencing device (e.g., a receiver device) may lose and/or otherwise be unable to access the conferencing data (e.g., audio data, video data, a combination of AV data) of an AV call due to interruptions in the network. As used herein, “video conferencing data,” “call input data,” and/or “input data” refers to video data and/or audio data included in a video conferencing call between at least two AV conferencing devices connected via a network. For example, video conferencing data may include human speech, human facial expressions, human movement, etc. In some examples, AV conferencing devices may be coupled to and/or otherwise include component devices (e.g., camera, microphone, etc.) to capture the video conferencing data.

One previous solution to recover video conferencing data is sometimes referred to as “playback speed tweaking.” For example, when there is intermittent network connectivity between AV conferencing devices, lost video conferencing data may be played back to a receiver device at a faster rate (e.g., 1.5× speed, 2× speed, etc.) than the original data. The lost video conferencing data may be recovered in this example, but the user experience at the receiver device is hindered by the rushed, hasty playback of otherwise valuable data. Moreover, playback speed tweaking may only be effective if there is enough bandwidth in the network to transmit the sped up data (e.g., audio packets having a size of 40 kilobits per second (Kbps), 50 Kbps, etc.). Put differently, the sped up data may be too large of a file to transmit over a low bandwidth network.

Another previous solution to recover video conferencing data includes automatic and/or manual efforts to reconnect to a network. For example, a user of a video conferencing device may attempt to manually reconnect to a network router after the network is interrupted. However, additional video conferencing data may be lost in the time delay between the network disconnection and the manual reconnection. As such, reconnection efforts may not be able to recover the video conferencing data and can continue to aggravate the user experience of AV conferencing devices.

Examples disclosed herein maintain the continuity of video conferencing calls by regenerating (e.g., reconstructing) video conferencing data during low bandwidth and/or intermittent network connection. Disclosed examples generate an example representation that captures the video conferencing data without losing valuable information (e.g., words, business context, human emotions, vocal tone, facial expressions, etc.) that was transmitted (e.g., broadcast) by or from a source device in the video call. For example, disclosed examples access a transcript of video conferencing data to, in turn, generate a representation (e.g., one or more data structures) of the transcript at a receiver device. In some examples, the transcript may include a file size of 2-3 Kbps. As such, disclosed examples can recover video conferencing data when the network bandwidth limits transmissions to as low as 4 Kbps, for example. Thus, disclosed examples improve the user experience of AV conferencing devices when performance metrics (e.g., data transmission capacity) associated with an example network deteriorate. In some examples, disclosed examples employ neural processing units (NPUs) to generate the transcript of the video conferencing data from a first video conferencing device (e.g., a sender device). Additionally, some disclosed examples employ audio/visual (AV) regeneration techniques to generate the representation (e.g., an avatar representation of a user with synthesized speech) of the video conferencing data on a second video conferencing device (e.g., on the receiver device). Further, some disclosed examples cause a video conferencing device to resume live streaming of the video conferencing data when the network bandwidth recovers (e.g., is greater than a threshold value).

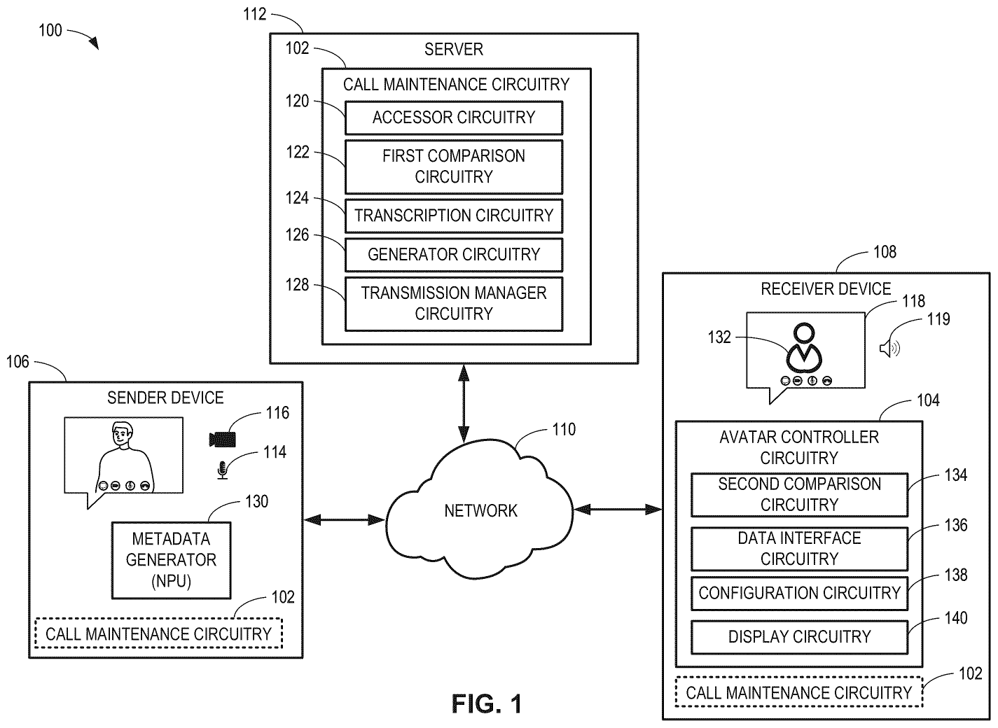

FIG. 1 is a block diagram of an example environment 100 in which example call maintenance circuitry 102 and/or example avatar controller circuitry 104 operates to manage video conferencing call data. The example environment 100 includes an example sender device 106, an example receiver device 108, an example network 110, and an example server 112. In the illustrated example, the example sender device 106 and the receiver device 108 are communicatively coupled via the network 110. A user of the example sender device 106 may be engaged in a video conferencing call with a user of the receiver device 108 such that the users can communicate via video and/or audio. In particular, the example sender device 106 may gather video conferencing data associated with the user of the sender device 106 that, in turn, can be transmitted to the receiver device 108. The example sender device 106 may include and/or otherwise be coupled to an example microphone 114, an example camera 116, etc., to facilitate gathering the video conferencing data. Similarly, the example receiver device 108 may include and/or otherwise be coupled to a display screen (e.g., an example user interface 118), an example speaker 119, etc., to access (e.g., view, hear, etc.) the video conferencing data. In the example of FIG. 1, there is one sender device 106 and one receiver device 108. However, there may be any number of sender devices and/or any number of receiver devices participating in an example video conferencing call.

In some examples, the server 112 may facilitate the transmission of the video conferencing data from the sender device 106 to the receiver device 108 (e.g., over the network 110). In this example the server 112 includes the call maintenance circuitry 102. However, in other examples, the call maintenance circuitry 102 may reside in and/or be implemented by the sender device 106, the receiver device 108, and/or any other computing device coupled to the network 110. The network 110 may be the Internet. However, the example network 110 may be implemented using any suitable wired and/or wireless network(s) including, for example, one or more data buses, one or more local area networks (LANs), one or more wireless LANs, one or more cellular networks, one or more private networks, one or more public networks, etc. Further, the example network 110 enables the server 112, the sender device 106, and/or the receiver device 108 to communicate.

The example call maintenance circuitry 102 operates to manage the video conferencing call data between the sender device 106 and the receiver device 108. The example call maintenance circuitry 102 includes example accessor circuitry 120, first example comparison circuitry 122, example transcription circuitry 124, example generator circuitry 126, and example transmission manager circuitry 128. The example call maintenance circuitry 102 of FIG. 1 may be instantiated (e.g., creating an instance of, bring into being for any length of time, materialize, implement, etc.) by programmable circuitry such as a Central Processor Unit (CPU) executing first instructions. Additionally or alternatively, the example call maintenance circuitry 102 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

The example accessor circuitry 120 accesses (e.g., retrieve, receive, etc.) video conferencing data associated with the sender device 106. For example, the accessor circuitry 120 can access video data and/or audio data including human speech, human facial expressions, human movement, etc., associated with a user of the sender device 106. In some examples, the accessor circuitry 120 may access the video data and/or audio data via at least one component device (e.g., the camera 116, the microphone 114, etc.) associated with the sender device 106. In some examples, the accessor circuitry 120 may access video data and/or audio data having a file size (e.g., bandwidth value) of about 50 Kbps (e.g., within 10 Kbps).

The first example comparison circuitry 122 compares a performance metric corresponding to the network 110 to a threshold value. In some examples, the performance metric associated with the network 110 includes at least one of a bandwidth value, a latency value, a packet loss value, or a jitter value. In some examples, the first comparison circuitry 122 is communicatively coupled to the sender device 106 and the receiver device 108 to determine performance metrics (e.g., connection issues, battery capacity, processor bandwidth, etc.) associated with at least one of the sender device 106 or the receiver device 108. Further, the example threshold value may indicate limits associated with the performance metric. For example, a threshold value of 10 Kbps indicates that the network 110 may not be able to transmit video data and/or audio data that exceeds 10 Kbps. If the performance metric indicates a bandwidth value of 40 Kbps and the threshold value is 10 Kbps, then the first example comparison circuitry 122 determines that the performance metric satisfies (e.g., is greater than) the threshold value (e.g., 40 Kbps>10 Kbps). In such examples, video data and/or audio data having a file size greater than 10 Kbps can be transmitted via the network 110. Alternatively, if the performance metric is 4 Kbps and the threshold value is 10 Kbps, then the first example comparison circuitry 122 determines that the performance metric does not satisfy (e.g., is less than) the threshold value (e.g., 4 Kbps<10 Kbps). In such examples, video data and/or audio data having a file size greater than 10 Kbps transmitted via the network 110 may be subject to interruptions, lost data, etc.

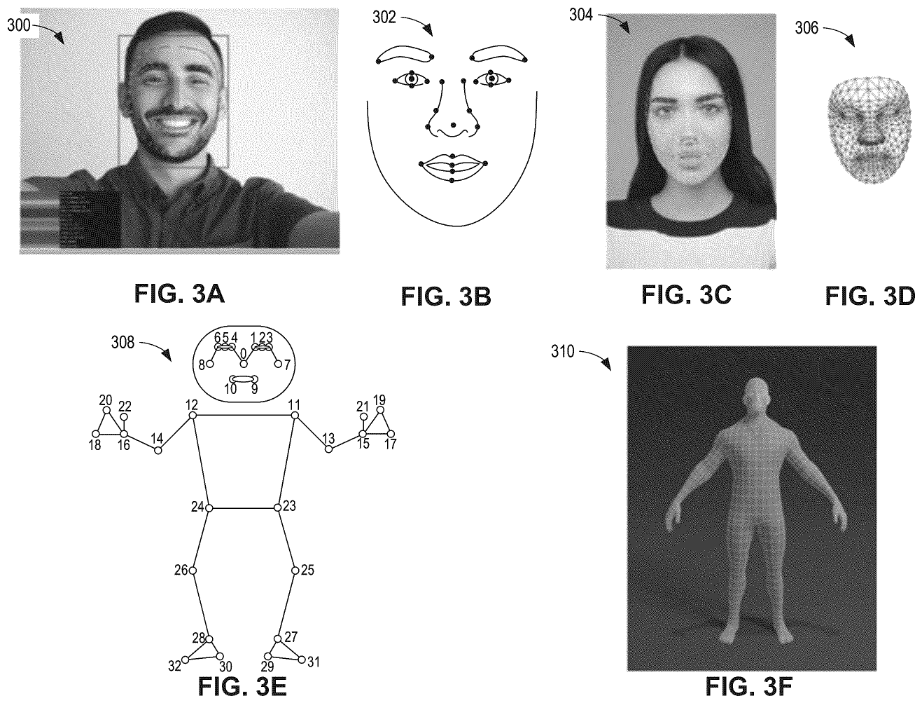

In some examples, the transcription circuitry 124 generates a transcript of video data and/or audio data when the performance metric does not satisfy the threshold value (e.g., the performance metric is less than the threshold value for available bandwidth, the performance metric is greater than the threshold value of latency, etc.). However, the transcription circuitry 124 may be continuously generating a transcript of the video data and/or audio data when the performance metric satisfies the threshold value (e.g., is greater than the threshold value, depending on a type of performance metric associated with the threshold value). In some examples, the transcription circuitry 124 generates a transcript (e.g., a text file) that associates the video data and/or audio data with timestamps. In some examples, the transcription circuitry 124 generates a transcript that associates speech metadata of a user of the sender device 106 with timestamps (e.g., in chronological order). As used herein, “speech metadata” refers to qualities and/or properties associated with human speech. For example, speech metadata can include volume, tone of voice, prosody, pitch, intensity, voice quality, articulation, pronunciation, accents, fluency, vocal nature, etc. Additionally or alternatively, the transcription circuitry 124 generates a transcript that associates movement metadata of a user of the sender device 106 with timestamps. As used herein, “movement metadata” refers to qualities and/or properties associated with human movement. For example, movement metadata can include human facial expressions (e.g., smiles, yawns, emotion, etc.), body gestures, body poses, hand waving, head motions, head orientations, etc. In some examples, the transcription circuitry 124 generates the transcript to include words, movement metadata, speech metadata, timestamps, etc., that illustrate (e.g., mirror, reconstruct, etc.) the video data and/or audio data associated with a user of the sender device 106. In some examples, the transcription circuitry 124 generates a transcript having a file size of about 2 Kbps (e.g., within 1 Kbps). Additionally, the example transcription circuitry 124 may be communicatively coupled to example extraction models (e.g., example metadata generator neural processing unit (NPU) 130) to access the speech metadata and/or the movement data, as described below in connection with FIGS. 3A-3F.

In some examples, the generator circuitry 126 generates (e.g., create, construct, etc.) one or more representations of the video data and/or audio data when the performance metric is less than the threshold value. In some examples, the generator circuitry 126 generates the representation of the video data and/or audio data based on the transcript (created by the transcription circuitry 124). In particular, the generator circuitry 126 can generate the representation of the video data and/or audio data as a set of machine-readable instructions that track/match the transcript. Further, such instructions may correspond to and/or otherwise be compatible with an example avatar representation (e.g., avatar) 132 stored on the receiver device 108. In other words, the example representation may include instructions that dictate (e.g., control, instruct, etc.) movements (e.g., facial movements) and/or speech of the avatar representation 132. The example avatar representation 132 includes similar characteristics (e.g., facial features, head shape, hair color, voice information, etc.) to a user of the sender device 106. In an example scenario, the transcript may indicate (in a text file) that a user of the sender device 106 whispered the phrase “Please search your email.” at a volume of 30 decibels (dB) at a timestamp of 10:46:10 AM central standard time (CST) while also raising his/her left eyebrow. Then, the example generator circuitry 126 can generate a representation of the transcript as a set of instructions (e.g., at time 10:46:10 AM CST, recite the phrase “Please search your email.” at a volume of 30 dB and raise the left eyebrow) for the avatar representation 132. In some examples, the generator circuitry 126 generates such a representation that has a file size (e.g., bandwidth value) of about 2 Kbps. As such, the representation of the video data and/or audio data can have a file size less than the file size of the video data and/or audio data (e.g., 2 Kbps<50 Kbps). In some examples, as the performance metric associated with the threshold value continues to decrease, the generator circuitry 126 removes portions of the transcript to generate a smaller transcript. For example, in the machine-readable instructions to recite the phrase “Please search your email.” at a volume of 30 dB and raise the left eyebrow at time 10:46:10 AM CST, the generator circuitry 126 can remove the detail about the left eyebrow from the transcript to generate a smaller file size.

The example transmission manager circuitry 128 transmits the representation to the receiver device 108 via the network 110. In some examples, the transmission manager circuitry 128 prevents (e.g., blocks, suppresses, pauses, etc.) the video data and/or the audio data from transmission via the network 110 when the performance metric is less than the threshold value. In other words, when the network 110 is not capable of transmitting the relatively larger video data and/or audio data, the example transmission manager circuitry 128 prevents streaming of the video data and/or audio data over the network 110. In such examples, the transmission manager circuitry 128 transmits the representation of the video data and/or audio data (e.g., instead of the larger video data and/or audio data) to the receiver device 108 via the network 110. However, if the performance metric is greater than the threshold value (e.g., the network 110 is capable of sustaining the relatively larger video data and/or audio data), then the example transmission manager circuitry 128 transmits the video data and/or audio data to the receiver device 108 via the network 110. In other words, the transmission manager circuitry 128 can resume streaming of the video data and/or audio data when the network 110 has enough bandwidth to support such a file size (e.g., 50 Kbps). In other examples, if there are relatively frequent and/or intermittent increases/decreases in the performance metric (e.g., every 2 or 3 seconds), then the transmission manager circuitry 128 can prevent transmissions of the video data and/or audio data via the network 110 until transient characteristics of the performance metric decreases and/or otherwise steadies below the threshold value (e.g., remains less than the threshold value for more than 5 seconds). Put differently, the transmission manager circuitry 128 can continue transmitting the representation of the video data and/or audio data when the performance metric associated with the network 110 is unknown, sporadic, inconsistent, etc.

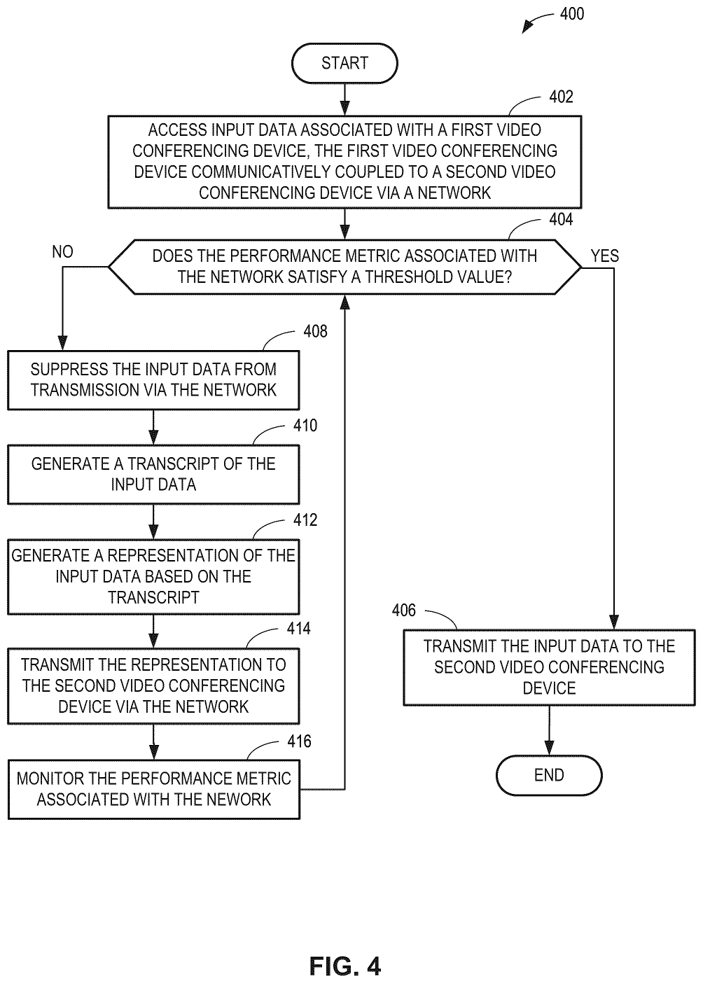

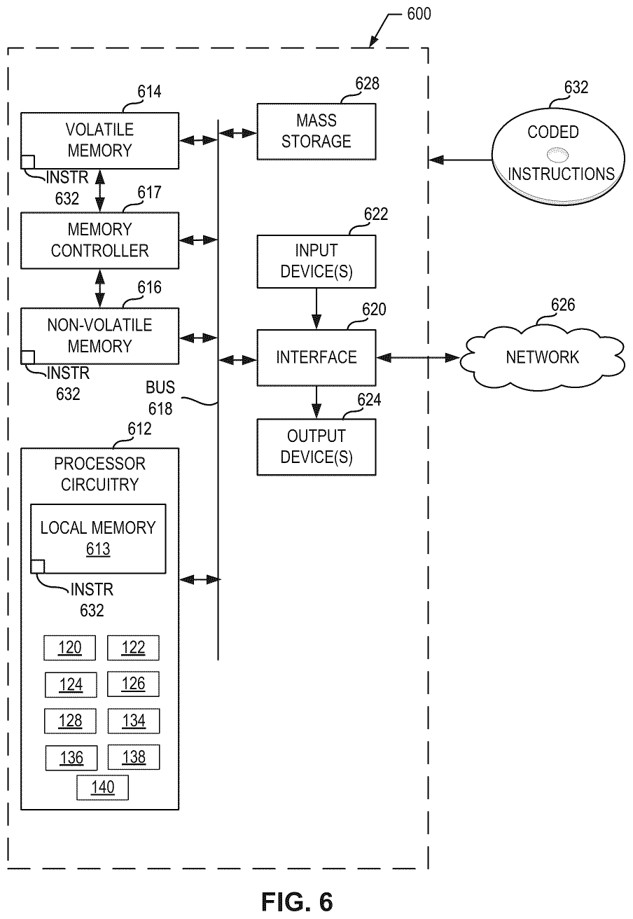

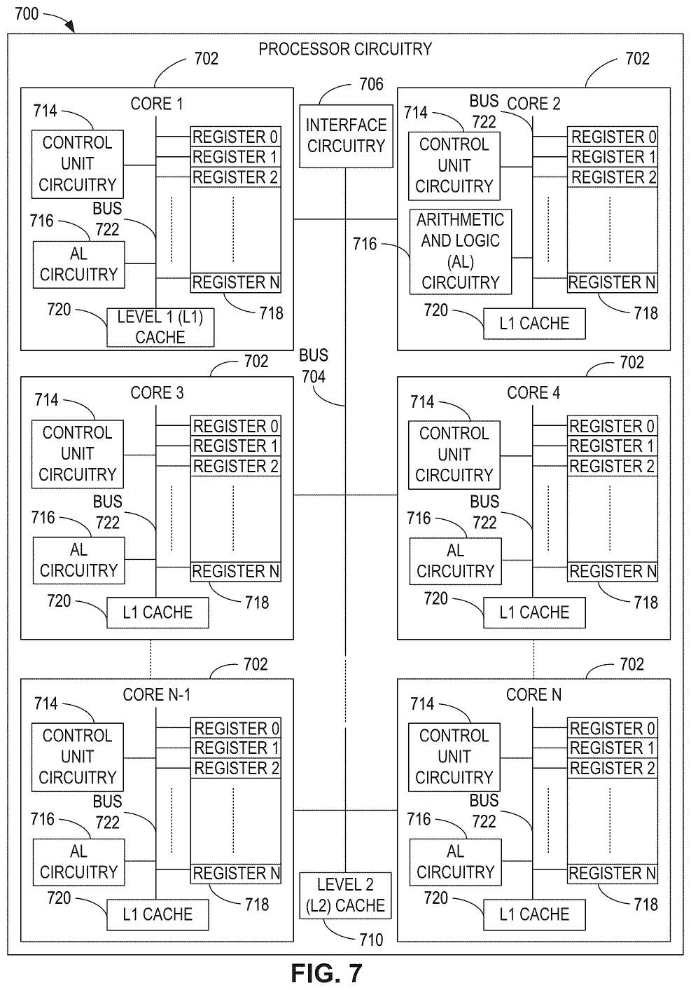

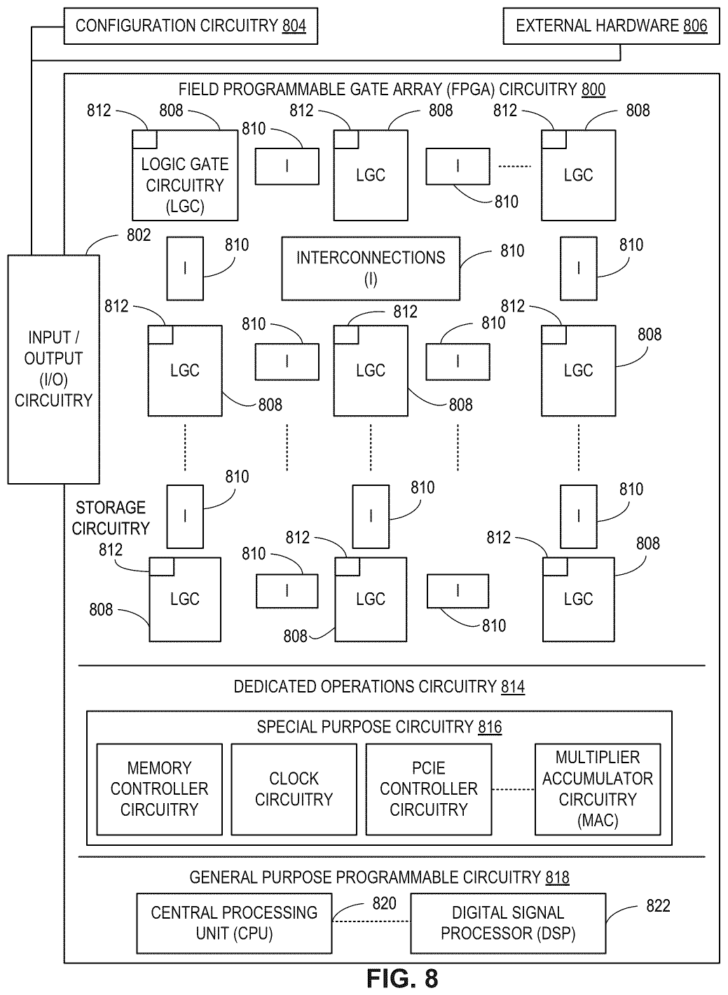

In some examples, the accessor circuitry 120 is instantiated by programmable circuitry executing accessing instructions and/or configured to perform operations such as those represented by the flowchart of FIG. 4. In some examples, the example call maintenance circuitry 102 includes first means for accessing video data and/or audio data. For example, the first means for determining may be implemented by the accessor circuitry 120. In some examples, the accessor circuitry 120 may be instantiated by programmable circuitry such as the example programmable circuitry 612 of FIG. 6. For instance, the accessor circuitry 120 may be instantiated by the example microprocessor 700 of FIG. 7 executing machine executable instructions such as those implemented by at least block 402 of FIG. 4. In some examples, the accessor circuitry 120 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the accessor circuitry 120 may be instantiated by any other combination of hardware, software, and/or firmware. For example, the accessor circuitry 120 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the first comparison circuitry 122 is instantiated by programmable circuitry executing comparing instructions and/or configured to perform operations such as those represented by the flowchart of FIG. 4. In some examples, the example call maintenance circuitry 102 includes first means for comparing the performance metric with a threshold value. For example, the first means for comparing may be implemented by the first comparison circuitry 122. In some examples, the first comparison circuitry 122 may be instantiated by programmable circuitry such as the example programmable circuitry 612 of FIG. 6. For instance, the first comparison circuitry 122 may be instantiated by the example microprocessor 700 of FIG. 7 executing machine executable instructions such as those implemented by at least blocks 404, 416 of FIG. 4. In some examples, the first comparison circuitry 122 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the first comparison circuitry 122 may be instantiated by any other combination of hardware, software, and/or firmware. For example, the first comparison circuitry 122 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the transcription circuitry 124 is instantiated by programmable circuitry executing transcription instructions and/or configured to perform operations such as those represented by the flowchart of FIG. 4. In some examples, the example call maintenance circuitry 102 includes second means for generating a transcript (e.g., a transcript packet). For example, the second means for generating may be implemented by the transcription circuitry 124. In some examples, the transcription circuitry 124 may be instantiated by programmable circuitry such as the example programmable circuitry 612 of FIG. 6. For instance, the transcription circuitry 124 may be instantiated by the example microprocessor 700 of FIG. 7 executing machine executable instructions such as those implemented by at least block 410 of FIG. 4. In some examples, the transcription circuitry 124 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the transcription circuitry 124 may be instantiated by any other combination of hardware, software, and/or firmware. For example, the transcription circuitry 124 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the generator circuitry 126 is instantiated by programmable circuitry executing generating instructions and/or configured to perform operations such as those represented by the flowchart of FIG. 4. In some examples, the example call maintenance circuitry 102 includes first means for generating a representation (e.g., machine-readable instructions). For example, the first means for generating may be implemented by the generator circuitry 126. In some examples, the generator circuitry 126 may be instantiated by programmable circuitry such as the example programmable circuitry 612 of FIG. 6. For instance, the generator circuitry 126 may be instantiated by the example microprocessor 700 of FIG. 7 executing machine executable instructions such as those implemented by at least block 412 of FIG. 4. In some examples, the generator circuitry 126 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the generator circuitry 126 may be instantiated by any other combination of hardware, software, and/or firmware. For example, the generator circuitry 126 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the transmission manager circuitry 128 is instantiated by programmable circuitry executing transmission instructions and/or configured to perform operations such as those represented by the flowchart of FIG. 4. In some examples, the example call maintenance circuitry 102 includes means for transmitting a representation. For example, the means for transmitting may be implemented by the transmission manager circuitry 128. In some examples, the transmission manager circuitry 128 may be instantiated by programmable circuitry such as the example programmable circuitry 612 of FIG. 6. For instance, the transmission manager circuitry 128 may be instantiated by the example microprocessor 700 of FIG. 7 executing machine executable instructions such as those implemented by at least blocks 408, 414, 406 of FIG. 4. In some examples, the transmission manager circuitry 128 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the transmission manager circuitry 128 may be instantiated by any other combination of hardware, software, and/or firmware. For example, the transmission manager circuitry 128 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the receiver device 108 includes example avatar controller circuitry 104 to process the representation of the video data and/or audio data from the sender device 106. The example avatar controller circuitry 104 includes second example comparison circuitry 134, example data interface circuitry 136, example configuration circuitry 138, and example display circuitry 140. The example avatar controller circuitry 104 of FIG. 1 may be instantiated (e.g., creating an instance of, bring into being for any length of time, materialize, implement, etc.) by programmable circuitry such as a Central Processor Unit (CPU) executing first instructions. Additionally or alternatively, the example avatar controller circuitry 104 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

The second example comparison circuitry 134 compares the performance metric associated with the network 110 to the threshold value. The second example comparison circuitry 134 determines whether the performance metric satisfies (e.g., is less than) the threshold value. For example, if the second comparison circuitry 134 determines that the performance metric is less than the threshold value, then the data interface circuitry 136 accesses and/or otherwise causes the machine-readable instructions to generate a proxy of the video data and/or audio data. In particular, the example data interface circuitry 136 accesses and/or otherwise instantiates the machine-readable instructions (generated by the generator circuitry 126) that track/match the transcript (generated by the transcription circuitry 124). In this example, these machine-readable instructions provide commands, controls, operations, etc., to generate a proxy of the video data and/or audio data.

The example configuration circuitry 138 configures, structures and/or otherwise generates (e.g., programs, encodes, etc.) a proxy (e.g., a data structure containing information associated with a series of actions, motions, facial expressions, words, etc.) of the video data and/or audio data based on the machine-readable instructions. For example, the configuration circuitry 138 generates such a proxy by accessing the avatar representation 132 of a user of the sender device 106. In some examples, the avatar representation 132 may be stored in a database associated with the receiver device 108 and/or accessed by the avatar controller circuitry 104 (e.g., at the beginning of the video conferencing call). Then, the example configuration circuitry 138 configures the avatar representation 132 to simulate the proxy (e.g., at time 10:46:10 AM CST, the avatar representation 132 recites the phrase “Please search your email.” at a volume of 30 dB and raises the left eyebrow). In this example, the configuration circuitry 138 ensures that the lip movements of the avatar representation 132 are matched (e.g., synced) with the words in the synthesized speech.

The example display circuitry 140 displays (e.g., presents, illustrates, etc.) the proxy on the user interface 118 of the receiver device 108. For example, the display circuitry 140 plays audio data (e.g., synthesized speech of the user of the sender device 106) on the speaker 119 based on the machine-readable instructions. Additionally, the example display circuitry 140 illustrates the motions, gestures, etc., of the avatar representation 132 on the user interface 118 of the receiver device 108 based on the machine-readable instructions. In other examples, when the second comparison circuitry 134 determines that the performance value satisfies (e.g., is greater than) the threshold value, then the display circuitry 140 displays the video data and/or audio data (from the sender device 106) on the user interface 118 of the receiver device 108.

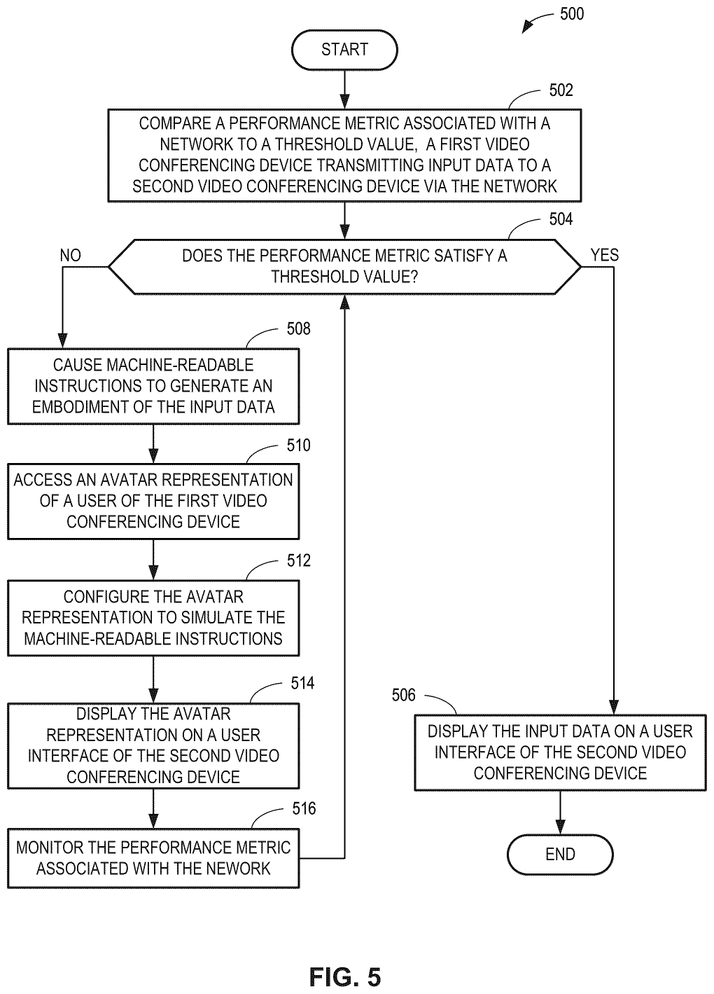

In some examples, the second comparison circuitry 134 is instantiated by programmable circuitry executing comparing instructions and/or configured to perform operations such as those represented by the flowchart of FIG. 5. In some examples, the example avatar controller circuitry 104 includes second means for comparing. For example, the second means for comparing may be implemented by the second comparison circuitry 134. In some examples, the second comparison circuitry 134 may be instantiated by programmable circuitry such as the example programmable circuitry 612 of FIG. 6. For instance, the second comparison circuitry 134 may be instantiated by the example microprocessor 700 of FIG. 7 executing machine executable instructions such as those implemented by at least blocks 502, 504, 516 of FIG. 5. In some examples, the second comparison circuitry 134 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the second comparison circuitry 134 may be instantiated by any other combination of hardware, software, and/or firmware. For example, the second comparison circuitry 134 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the data interface circuitry 136 is instantiated by programmable circuitry executing accessing instructions and/or configured to perform operations such as those represented by the flowchart of FIG. 5. In some examples, the example avatar controller circuitry 104 includes second means for accessing machine-readable instructions. For example, the second means for accessing may be implemented by the data interface circuitry 136. In some examples, the data interface circuitry 136 may be instantiated by programmable circuitry such as the example programmable circuitry 612 of FIG. 6. For instance, the data interface circuitry 136 may be instantiated by the example microprocessor 700 of FIG. 7 executing machine executable instructions such as those implemented by at least block 508 of FIG. 5. In some examples, the data interface circuitry 136 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the data interface circuitry 136 may be instantiated by any other combination of hardware, software, and/or firmware. For example, the data interface circuitry 136 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the configuration circuitry 138 is instantiated by programmable circuitry executing configuration instructions and/or configured to perform operations such as those represented by the flowchart of FIG. 5. In some examples, the example avatar controller circuitry 104 includes means for encoding a proxy. For example, the means for encoding may be implemented by the configuration circuitry 138. In some examples, the configuration circuitry 138 may be instantiated by programmable circuitry such as the example programmable circuitry 612 of FIG. 6. For instance, the configuration circuitry 138 may be instantiated by the example microprocessor 700 of FIG. 7 executing machine executable instructions such as those implemented by at least blocks 510, 512 of FIG. 5. In some examples, the configuration circuitry 138 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the configuration circuitry 138 may be instantiated by any other combination of hardware, software, and/or firmware. For example, the configuration circuitry 138 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the display circuitry 140 is instantiated by programmable circuitry executing display instructions and/or configured to perform operations such as those represented by the flowchart of FIG. 5. In some examples, the example avatar controller circuitry 104 includes means for displaying a proxy. For example, the means for displaying may be implemented by the display circuitry 140. In some examples, the display circuitry 140 may be instantiated by programmable circuitry such as the example programmable circuitry 612 of FIG. 6. For instance, the display circuitry 140 may be instantiated by the example microprocessor 700 of FIG. 7 executing machine executable instructions such as those implemented by at least block 506, 514 of FIG. 5. In some examples, the display circuitry 140 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the display circuitry 140 may be instantiated by any other combination of hardware, software, and/or firmware. For example, the display circuitry 140 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

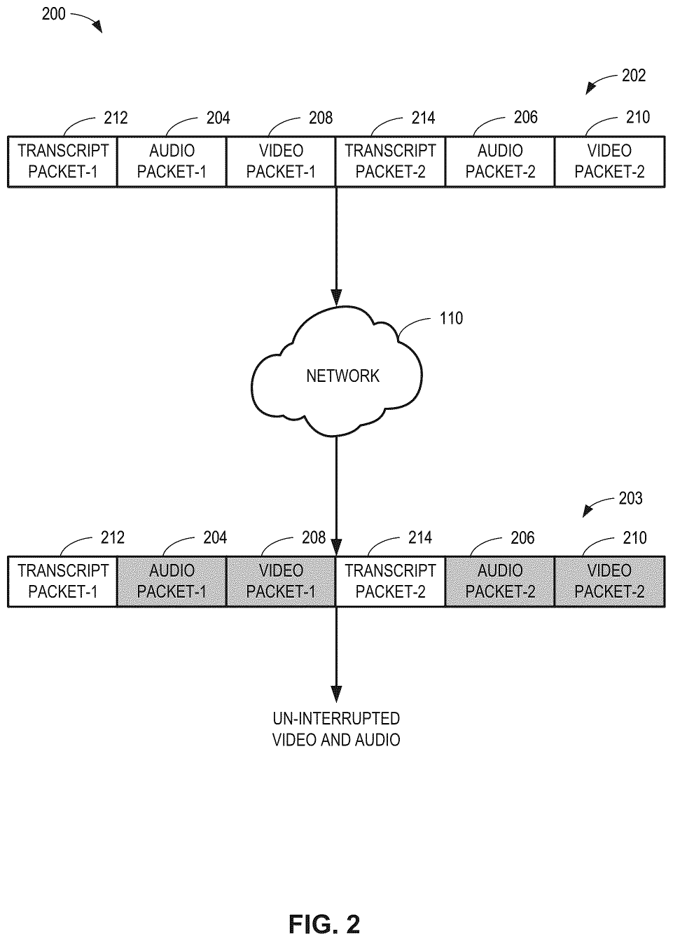

FIG. 2 is an example schematic diagram 200 illustrating an implementation of the example call maintenance circuitry 102 and/or the example avatar controller circuitry 104 of FIG. 1. The example schematic diagram 200 includes the network 110, example collected data 202, and example transmitted data 203. The example collected data 202 includes example audio packets 204, 206, example video packets 208, 210, and example transcript packets 212, 214. The example audio packets 204, 206 include audio files representing the call input data and the example video packets 208, 210 include video files representing the call input data. Further, the example transcript packets 212, 214 include transcripts (e.g., text files including speech metadata, movement metadata, timestamps, etc.) of the call input data. The example schematic diagram 200 illustrates a framework to filter the collected data 202 based on a performance metric associated with the network 110. In this example, the network 110 has a performance metric that is less than the threshold value. For example, the network 110 has a relatively low performance metric of 4 Kbps. As such, packets in the collected data 202 exceeding 4 Kbps may not be transmitted over the network 110. As shown in the illustrated example of FIG. 2, the audio packets 204, 206 and the video packets 208, 210 include sizes that are about 50 Kbps. Thus, packets 204, 206, 208, 210 are too large (e.g., 50 Kbps, 100 Kbps, etc.) to be transmitted over the network 110 (and are shaded out accordingly in the transmitted data 203). In some examples, the avatar controller circuitry 104 determines the performance metric of the network 110 based on an absence of and/or interruptions in the delivery of the video packets 208, 210 and/or the audio packets 204, 206. For example, at least one of the first comparison circuitry 122 and/or the second comparison circuitry 134 can determine that the performance metric is less than the threshold value when at least one of the audio packets 204, 206, or the video packets 208, 210 are not transmitted to the receiver device 108.

As shown in the illustrated example of FIG. 2, the transcription circuitry 124 generates the transcript packets 212, 214 having a file size of 2 Kbps. As such, the example transmission manager circuitry 128 can transmit the transcript packets 212, 214 via the network 110 (even though the network 110 has a relatively low bandwidth of 10 Kbps). In turn, the transcript packets 212, 214 can be processed by at least the avatar controller circuitry 104 to generate, modify, animate, etc., the avatar representation 132 (FIG. 1) of the video data and/or audio data, resulting in little to no interruptions in the video conferencing call. In some examples, the avatar controller circuitry 104 can trigger the transcription circuitry 124 to generate (and or transmit) the transcript packets 212, 214 when at least one of the audio packets 204, 206, or the video packets 208, 210 are not transmitted to the receiver device 108. As such, the example server 112 can conserve power by only generating the transcript packets 212, 214 when the performance metric associated with the network 110 is less than the threshold value.

In the network bandwidth example of FIG. 2, the transcript packets 212, 214 may be prioritized over the example audio packets 204, 206 and the video packets 208, 210 based on the relatively small file size of the transcript packets 212, 214. In some examples, the audio packets 204, 206 (e.g., 30 Kbps) may be smaller than the video packets 208, 210 (e.g., 50 Kbps) and, as such, may be prioritized over the video packets 208, 210. However, such example audio packets 204, 206 are too large to be transmitted over the network 110 in the example of FIG. 2 (e.g., 30 Kbps>10 Kbps).

FIGS. 3A-3F illustrate example image recognition techniques for use with examples disclosed herein. Turning to FIG. 3A, example image recognition techniques, such as face meshing, can be used to generate an avatar representation of user 300. For example, facial landmarks associated with the user 300 can be extracted from an image (e.g., an image captured by the camera 116 corresponding to the sender device 106) of the user 300. FIG. 3B illustrates example landmarks 302 extracted from the face meshing technique of FIG. 3A. For example, the landmarks 302 are facial landmarks represented by the shaded data points (e.g., dots) in FIG. 3B, and can include “NoseTip,” “UpperLipTop,” “UpperLipBottom,” “PupilRight,” “EyeRightOuter,” “EyeRightInner,” “EyebrowLeftInner,” etc.

Turning to FIG. 3C, example image recognition techniques, such as face meshing, can be used to generate an avatar representation of the user 304. Similar to FIG. 3A, facial landmarks associated with the user 304 can be extracted from an image of the user 304. For example, example landmarks 306 may be facial landmarks of the user 304 represented by shaded dots and lines (e.g., contours) in the avatar representation in FIG. 3D, and can include forehead movement, cheek movement, eye lid movement, etc. In some examples, there may be about 450 data points (e.g., within 20 data points) of landmarks associated with the user 304.

Turning to FIGS. 3E and 3F, example image recognition techniques, such as body meshing, can be used to generate an avatar representation of a user of the sender device 106 (e.g., based on an image captured by the camera 116). For example, body landmarks of the user may be data points represented by dots and lines (e.g., contours) in example avatar representations 308, 310 in FIGS. 3E and 3F, and can include gestures, shoulder movement, elbow movement, finger movement, wrist movement, foot movement, head movement, face movement, etc.

In some examples, the transcription circuitry 124 generates an example transcript (e.g., the transcript packets 212, 214) to include information associated with the facial landmarks described in connection with FIGS. 3A-3F. Additionally or alternatively, the example transcription circuitry 124 generates an example transcript to include information associated with the body landmarks described in connection with FIGS. 3E and 3F. In some examples, the transcription circuitry 124 determines which and/or how many of the data points/landmarks to include in the transcript packets 212, 214 based on the performance metric associated with the network 110.

While an example manner of implementing the example call maintenance circuitry 102 and/or the example avatar controller circuitry 104 of FIG. 1 is illustrated in FIG. 1, one or more of the elements, processes, and/or devices illustrated in FIG. 1 may be combined, divided, re-arranged, omitted, eliminated, and/or implemented in any other way. Further, the example accessor circuitry 120, the first example comparison circuitry 122, the example transcription circuitry 124, the example generator circuitry 126, the example transmission manager circuitry 128, the second example comparison circuitry 134, the example data interface circuitry 136, the example configuration circuitry 138, the example display circuitry 140 and/or, more generally, the example call maintenance circuitry 102 and/or the example avatar controller circuitry 104 of FIG. 1, may be implemented by hardware alone or by hardware in combination with software and/or firmware. Thus, for example, any of the example accessor circuitry 120, the first example comparison circuitry 122, the example transcription circuitry 124, the example generator circuitry 126, the example transmission manager circuitry 128, the second example comparison circuitry 134, the example data interface circuitry 136, the example configuration circuitry 138, the example display circuitry 140, and/or, more generally, the example call maintenance circuitry 102 and/or the example avatar controller circuitry 104, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example call maintenance circuitry 102 and/or the example avatar controller circuitry 104 of FIG. 1 may include one or more elements, processes, and/or devices in addition to, or instead of, those illustrated in FIG. 1, and/or may include more than one of any or all of the illustrated elements, processes and devices.

Flowchart(s) representative of example machine readable instructions, which may be executed by programmable circuitry to implement and/or instantiate the call maintenance circuitry 102 and/or the example avatar controller circuitry 104 of FIG. 1 and/or representative of example operations which may be performed by programmable circuitry to implement and/or instantiate the call maintenance circuitry 102 and/or the example avatar controller circuitry 104 of FIG. 1, are shown in FIGS. 4 and 5. The machine readable instructions may be one or more executable programs or portion(s) of one or more executable programs for execution by programmable circuitry such as the programmable circuitry 612 shown in the example programmable circuitry platform 600 discussed below in connection with FIG. 6 and/or may be one or more function(s) or portion(s) of functions to be performed by the example programmable circuitry (e.g., an FPGA) discussed below in connection with FIGS. 7 and/or 8. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 4 and 5, many other methods of implementing the example call maintenance circuitry 102 and/or the example avatar controller circuitry 104 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4 and 5 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 4 is a flowchart representative of example machine readable instructions and/or example operations 400 that may be executed, instantiated, and/or performed by programmable circuitry to manage data associated with a video conferencing call. The example machine-readable instructions and/or the example operations 400 of FIG. 4 begin at block 402, at which the example accessor circuitry 120 accesses input data (e.g., video data and/or audio data) associated with a first video conferencing device (e.g., the sender device 106), the sender device 106 communicatively coupled to a second video conferencing device (e.g., the receiver device 108) via a network (e.g., the network 110). In some examples, the accessor circuitry 120 accesses video data and/or audio data having a first file size (e.g., bandwidth value), such as 50 Kbps.

At block 404, the first example comparison circuitry 122 determines whether a performance metric associated with the network 110 satisfies a threshold value. For example, the first comparison circuitry 122 determines that a performance metric does not satisfy the threshold value when the latency of the network 110 is greater than a threshold value. If the performance metric indicates that the latency of the network 110 is 150 milliseconds (ms) and the threshold value of latency is 100 ms, then the first example comparison circuitry 122 determines that the performance metric does not satisfy (e.g., is greater than) the threshold value (e.g., 150 ms>100 ms). In such examples, control of the process proceeds to block 408. Alternatively, if the performance metric indicates a latency of 60 ms and the threshold value of latency is 100 ms, then the first example comparison circuitry 122 determines that the performance metric satisfies (e.g., is less than) the threshold value (e.g., 60 ms<100 ms). In such examples, control of the process proceeds to block 406.

In other examples, the first comparison circuitry 122 determines that a performance metric does not satisfy the threshold value when the network bandwidth is less than a threshold value. If the performance metric is 4 Kbps and the threshold value is 10 Kbps, then the first example comparison circuitry 122 determines that the performance metric does not satisfy (e.g., is less than) the threshold value (e.g., 4 Kbps<10 Kbps). In such examples, control of the process proceeds to block 408. Alternatively, if the performance metric indicates a bandwidth value of 40 Kbps and the threshold value is 10 Kbps, then the first example comparison circuitry 122 determines that the performance metric satisfies (e.g., is greater than) the threshold value (e.g., 40 Kbps>10 Kbps). In such examples, control of proceeds to block 406.

At block 408, the example transmission manager circuitry 128 suppresses the video data and/or audio data from transmission via the network 110. In this example, the video data and/or audio data may be too large of a file (e.g., 50 Kbps) to transmit over the network 110 (based on the performance metric and/or the threshold value). Thus, the example transmission manager circuitry 128 pauses the transmission of the video data and/or audio data via the network 110.

At block 410, the example transcription circuitry 124 generates a transcript (e.g., the transcript packets 212, 214) of the video data and/or audio data. For example, the transcription circuitry 124 generates a transcript (e.g., a text file) that associates the video data and/or audio data with timestamps. As such, the example transcription circuitry 124 generates the transcript to include words, movement metadata, speech metadata, timestamps, etc., that illustrates (e.g., mirrors, reconstructs, etc.) the video data and/or audio data associated with the sender device 106. In some examples, the transcription circuitry 124 generates a transcript having a file size of about 2 Kbps (e.g., within 1 Kbps).

At block 412, the example generator circuitry 126 generates a representation of the video data and/or audio data based on the transcript. For example, the generator circuitry 126 generates the representation of the video data and/or audio data as a set of machine-readable instructions that track/match the transcript. Further, such instructions may correspond to and/or otherwise be compatible with the avatar representation 132 stored on the receiver device 108. In other words, the example representation includes instructions that dictate movements (e.g., facial movements) and/or speech of the avatar representation 132. The example generator circuitry 126 generates instructions that have a file size of about 2 Kbps. As such, the machine-readable instructions that represent the video data and/or audio data can have a file size less than the file size of the video data and/or audio data (e.g., 2 Kbps<50 Kbps).

At block 414, the example transmission manager circuitry 128 transmits the representation to the receiver device 108 via the network 110. Therefore, when the performance metric is less than the threshold value (i.e., not strong enough to transmit the larger video data and/or audio data), the transmission manager circuitry 128 can transmit the machine-readable instructions that represent the video data and/or audio data because such instructions are smaller in file size (e.g., 2 Kbps<50 Kbps). In turn, the instructions transmitted by the transmission manager circuitry 128 can be converted to the avatar representation 132 of the video data and/or audio data on the receiver device 108 (described in detail in connection with FIG. 5 below).

At block 416, the first example comparison circuitry 122 monitors (e.g., accesses) the performance metric associated with the network 110.

At block 404, if the performance metric continues to be less than the threshold value, then control of the process proceeds through blocks 408-416. In other words, the transmission manager circuitry 128 may continue to transmit representation(s) of the video data and/or audio data to the receiver device 108 until the network 110 recovers (e.g., is greater than the threshold value). In some examples, if the first comparison circuitry 122 determines that there are frequent increases/decreases in the performance metric (e.g., every 2 or 3 seconds), then the transmission manager circuitry 128 prevents transmissions of the video data and/or audio data via the network 110 (block 408) until the performance metric steadies below the threshold value (e.g., remains less than the threshold value for more than 5 seconds). Put differently, the transmission manager circuitry 128 can continue transmitting the representation(s) of the video data and/or audio data when the performance metric associated with the network 110 is unknown, sporadic, inconsistent, etc. If the first comparison circuitry 122 determines that the performance metric is greater than the threshold value, then control of the process proceeds to block 406.

At block 406, the transmission manager circuitry 128 transmits the video data and/or audio data (e.g., the video packets 208, 210, the audio packets 204, 206, etc.) to the receiver device 108 via the network 110. Thus, the example transmission manager circuitry 128 resumes streaming of the video data and/or audio data when the network 110 has enough bandwidth to support such a file size (e.g., 50 Kbps). Then, the process ends.

FIG. 5 is a flowchart representative of example machine readable instructions and/or example operations 500 that may be executed, instantiated, and/or performed by programmable circuitry to manage data associated with a video conferencing call. The example machine-readable instructions and/or the example operations 500 of FIG. 5 begin at block 502, at which the second comparison circuitry 134 compares a performance metric associated with a network (e.g., the network 110) to a threshold value, a first video conferencing device (e.g., the sender device 106) transmitting input data (e.g., video data and/or audio data) to a second video conferencing device (e.g., the receiver device 108) via the network 110.

At block 504, the second example comparison circuitry 134 determines whether the performance metric satisfies a threshold value. For example, the second comparison circuitry 134 determines that a performance metric does not satisfy the threshold value when the latency of the network 110 is greater than a threshold value. If the performance metric indicates that the latency of the network 110 is 150 ms and the threshold value of latency is 100 ms, then the second example comparison circuitry 134 determines that the performance metric does not satisfy (e.g., is greater than) the threshold value (e.g., 150 ms>100 ms). In such examples, control of the process proceeds to block 508. Alternatively, if the performance metric indicates a latency of 60 ms and the threshold value of latency is 100 ms, then the second example comparison circuitry 134 determines that the performance metric satisfies (e.g., is less than) the threshold value (e.g., 60 ms<100 ms). In such examples, control of the process proceeds to block 506.

In other examples, the second comparison circuitry 134 determines that a performance metric does not satisfy the threshold value when the network bandwidth associated with the receiver device 108 is less than the threshold value. If the performance metric is 4 Kbps and the threshold value is 10 Kbps, then the second example comparison circuitry 134 determines that the performance metric does not satisfy (e.g., is less than) the threshold value (e.g., 4 Kbps<10 Kbps). In such examples, control of the process proceeds to block 508. Alternatively, if the performance metric indicates a bandwidth value of 40 Kbps and the threshold value is 10 Kbps, then the second example comparison circuitry 134 determines that the performance metric satisfies (e.g., is greater than) the threshold value (e.g., 40 Kbps>10 Kbps). In such examples, control of proceeds to block 506.

At block 508, the example data interface circuitry 136 causes machine-readable instructions (e.g., the machine-readable instructions generated by the generator circuitry 126) to generate a proxy (e.g., series of actions, motions, facial expressions, words, etc.) of the video data and/or audio data. For example, the example data interface circuitry 136 accesses the machine-readable instructions that track/match the transcript (generated by the transcription circuitry 124). In this example, these machine-readable instructions provide commands, controls, operations, etc., to generate a proxy of the video data and/or audio data.

At block 510, the example configuration circuitry 138 accesses an avatar representation (e.g., the avatar representation 132) of a user of the sender device 106. In some examples, the configuration circuitry 138 accesses the avatar representation 132 from a database associated with the receiver device 108 and/or a database associated with the receiver device 108 the sender device 106 (e.g., at the beginning of the video conferencing call).

At block 512, the example configuration circuitry 138 configures the avatar representation 132 to simulate the machine-readable instructions (e.g., at time 10:46:10 AM CST, the avatar representation 132 recites the phrase “Please search your email.” at a volume of 30 dB and raises the left eyebrow). In this example, the configuration circuitry 138 ensures that the lip movements of the avatar representation 132 are matched (e.g., synced) with the words in the synthesized speech.

At block 514, the example display circuitry 140 displays (e.g., causes display of) the avatar representation 132 on the receiver device 108. For example, the display circuitry 140 plays audio data (e.g., synthesized speech of the user of the sender device 106) on the speaker 119 based on the machine-readable instructions. Additionally, the example display circuitry 140 illustrates the motions, gestures, etc., of the avatar representation 132 on the user interface 118 of the receiver device 108 based on the machine-readable instructions.

At block 516, the second example comparison circuitry 134 monitors the performance metric associated with the network 110.

At block 504, if the performance metric continues to be less than the threshold value, then control of the process proceeds through blocks 508-516. In other words, the data interface circuitry 136 may continue to access instructions(s) to generate a proxy of the video data and/or audio data until the network 110 recovers (e.g., is greater than the threshold value). In some examples, if the second comparison circuitry 134 determines that there are frequent increases/decreases in the performance metric (e.g., every 2 or 3 seconds), then the data interface circuitry 136 proceeds with accessing the machine-readable instructions via the network 110 until the performance metric steadies below the threshold value (e.g., remains less than the threshold value for more than 5 seconds). Put differently, the display circuitry 140 can continue displaying the avatar representation 132 of the machine-readable instructions when the performance metric associated with the network 110 is unknown, sporadic, inconsistent, etc. If the second comparison circuitry 134 determines that the performance metric satisfies the threshold value, then control of the process proceeds to block 506.

At block 506, the example display circuitry 140 displays the video data and/or audio data (e.g., the video packets 208, 210, the audio packets 204, 206, etc.) on the receiver device 108 via the network 110. Thus, the example display circuitry 140 resumes streaming of the video data and/or audio data when the network 110 has enough bandwidth to support such a file size (e.g., 50 Kbps). Then, the process ends.

FIG. 6 is a block diagram of an example programmable circuitry platform 600 structured to execute and/or instantiate the example machine-readable instructions and/or the example operations of FIGS. 4 and 5 to implement the call maintenance circuitry 102 and/or the example avatar controller circuitry 104 of FIG. 1. The programmable circuitry platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a gaming console, a set top box, a headset (e.g., an augmented reality (AR) headset, a virtual reality (VR) headset, etc.) or other wearable device, or any other type of computing and/or electronic device.

The programmable circuitry platform 600 of the illustrated example includes programmable circuitry 612. The programmable circuitry 612 of the illustrated example is hardware. For example, the programmable circuitry 612 can be implemented by one or more integrated circuits, logic circuits, FPGAs, microprocessors, CPUs, GPUs, DSPs, and/or microcontrollers from any desired family or manufacturer. The programmable circuitry 612 may be implemented by one or more semiconductor based (e.g., silicon based) devices. In this example, the programmable circuitry 612 implements the example accessor circuitry 120, the first example comparison circuitry 122, the example transcription circuitry 124, the example generator circuitry 126, the example transmission manager circuitry 128, the second example comparison circuitry 134, the example data interface circuitry 136, the example configuration circuitry 138, the example display circuitry 140.

The programmable circuitry 612 of the illustrated example includes a local memory 613 (e.g., a cache, registers, etc.). The programmable circuitry 612 of the illustrated example is in communication with main memory 614, 616, which includes a volatile memory 614 and a non-volatile memory 616, by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617. In some examples, the memory controller 617 may be implemented by one or more integrated circuits, logic circuits, microcontrollers from any desired family or manufacturer, or any other type of circuitry to manage the flow of data going to and from the main memory 614, 616.

The programmable circuitry platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user (e.g., a human user, a machine user, etc.) to enter data and/or commands into the programmable circuitry 612. The input device(s) 622 can be implemented by, for example, an audio sensor, a microphone, a camera (still or video), a keyboard, a button, a mouse, a touchscreen, a trackpad, a trackball, an isopoint device, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 600 of the illustrated example also includes one or more mass storage discs or devices 628 to store firmware, software, and/or data. Examples of such mass storage discs or devices 628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 632, which may be implemented by the machine readable instructions of FIGS. 4 and 5, may be stored in the mass storage device 628, in the volatile memory 614, in the non-volatile memory 616, and/or on at least one non-transitory computer readable storage medium such as a CD or DVD which may be removable.

FIG. 7 is a block diagram of an example implementation of the programmable circuitry 612 of FIG. 6. In this example, the programmable circuitry 612 of FIG. 6 is implemented by a microprocessor 700. For example, the microprocessor 700 may be a general-purpose microprocessor (e.g., general-purpose microprocessor circuitry). The microprocessor 700 executes some or all of the machine-readable instructions of the flowcharts of FIGS. 4 and 5 to effectively instantiate the circuitry of FIG. 2 as logic circuits to perform operations corresponding to those machine readable instructions. In some such examples, the circuitry of FIG. 1 is instantiated by the hardware circuits of the microprocessor 700 in combination with the machine-readable instructions. For example, the microprocessor 700 may be implemented by multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine readable instructions and/or operations represented by the flowcharts of FIGS. 4 and 5.

The cores 702 may communicate by a first example bus 704. In some examples, the first bus 704 may be implemented by a communication bus to effectuate communication associated with one(s) of the cores 702. For example, the first bus 704 may be implemented by at least one of an Inter-Integrated Circuit (I2C) bus, a Serial Peripheral Interface (SPI) bus, a PCI bus, or a PCIe bus. Additionally or alternatively, the first bus 704 may be implemented by any other type of computing or electrical bus. The cores 702 may obtain data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2 cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an ALU) 716, a plurality of registers 718, the local memory 720, and a second example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic and/or logic operations on the data within the corresponding core 702. The AL circuitry 716 of some examples performs integer based operations. In other examples, the AL circuitry 716 also performs floating-point operations. In yet other examples, the AL circuitry 716 may include first AL circuitry that performs integer-based operations and second AL circuitry that performs floating-point operations. In some examples, the AL circuitry 716 may be referred to as an Arithmetic Logic Unit (ALU).

The registers 718 are semiconductor-based structures to store data and/or instructions such as results of one or more of the operations performed by the AL circuitry 716 of the corresponding core 702. For example, the registers 718 may include vector register(s), SIMD register(s), general-purpose register(s), flag register(s), segment register(s), machine-specific register(s), instruction pointer register(s), control register(s), debug register(s), memory management register(s), machine check register(s), etc. The registers 718 may be arranged in a bank as shown in FIG. 7. Alternatively, the registers 718 may be organized in any other arrangement, format, or structure, such as by being distributed throughout the core 702 to shorten access time. The second bus 722 may be implemented by at least one of an I2C bus, a SPI bus, a PCI bus, or a PCIe bus.

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages.

The microprocessor 700 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 700, in the same chip package as the microprocessor 700 and/or in one or more separate packages from the microprocessor 700.

FIG. 8 is a block diagram of another example implementation of the programmable circuitry 612 of FIG. 6. In this example, the programmable circuitry 612 is implemented by FPGA circuitry 800. For example, the FPGA circuitry 800 may be implemented by an FPGA. The FPGA circuitry 800 can be used, for example, to perform operations that could otherwise be performed by the example microprocessor 700 of FIG. 7 executing corresponding machine readable instructions. However, once configured, the FPGA circuitry 800 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 700 of FIG. 7 described above (which is a general purpose device that may be programmed to execute some or all of the machine readable instructions represented by the flowchart(s) of FIGS. 4 and 5 but whose interconnections and logic circuitry are fixed once fabricated), the FPGA circuitry 800 of the example of FIG. 8 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 4 and 5. In particular, the FPGA circuitry 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 4 and 5. As such, the FPGA circuitry 800 may be configured and/or structured to effectively instantiate some or all of the operations/functions corresponding to the machine readable instructions of the flowchart(s) of FIGS. 4 and 5 as dedicated logic circuits to perform the operations/functions corresponding to those software instructions in a dedicated manner analogous to an ASIC. Therefore, the FPGA circuitry 800 may perform the operations/functions corresponding to the some or all of the machine readable instructions of FIGS. 4 and 5 faster than the general-purpose microprocessor can execute the same.

In the example of FIG. 8, the FPGA circuitry 800 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

The FPGA circuitry 800 of FIG. 8, includes example input/output (I/O) circuitry 802 to obtain and/or output data to/from example configuration circuitry 804 and/or external hardware 806. For example, the configuration circuitry 804 may be implemented by interface circuitry that may obtain a binary file, which may be implemented by a bit stream, data, and/or machine-readable instructions, to configure the FPGA circuitry 800, or portion(s) thereof. In some such examples, the configuration circuitry 804 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 806 may be implemented by external hardware circuitry. For example, the external hardware 806 may be implemented by the microprocessor 700 of FIG. 7.

The FPGA circuitry 800 also includes an array of example logic gate circuitry 808, a plurality of example configurable interconnections 810, and example storage circuitry 812. The logic gate circuitry 808 and the configurable interconnections 810 are configurable to instantiate one or more operations/functions that may correspond to at least some of the machine readable instructions of FIGS. 4 and 5 and/or other desired operations. The logic gate circuitry 808 shown in FIG. 8 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations/functions. The logic gate circuitry 808 may include other electrical structures such as look-up tables (LUTs), registers (e.g., flip-flops or latches), multiplexers, etc.

The configurable interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example dedicated operations circuitry 814. In this example, the dedicated operations circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 8 illustrate two example implementations of the programmable circuitry 612 of FIG. 6, many other approaches are contemplated. For example, FPGA circuitry may include an on-board CPU, such as one or more of the example CPU 820 of FIG. 7. Therefore, the programmable circuitry 612 of FIG. 6 may additionally be implemented by combining at least the example microprocessor 700 of FIG. 7 and the example FPGA circuitry 800 of FIG. 8. In some such hybrid examples, one or more cores 702 of FIG. 7 may execute a first portion of the machine readable instructions represented by the flowchart(s) of FIGS. 4 and 5 to perform first operation(s)/function(s), the FPGA circuitry 800 of FIG. 8 may be configured and/or structured to perform second operation(s)/function(s) corresponding to a second portion of the machine readable instructions represented by the flowcharts of FIGS. 4 and 5, and/or an ASIC may be configured and/or structured to perform third operation(s)/function(s) corresponding to a third portion of the machine readable instructions represented by the flowcharts of FIGS. 4 and 5.

It should be understood that some or all of the circuitry of FIG. 1 may, thus, be instantiated at the same or different times. For example, same and/or different portion(s) of the microprocessor 700 of FIG. 7 may be programmed to execute portion(s) of machine-readable instructions at the same and/or different times. In some examples, same and/or different portion(s) of the FPGA circuitry 800 of FIG. 8 may be configured and/or structured to perform operations/functions corresponding to portion(s) of machine-readable instructions at the same and/or different times.

In some examples, some or all of the circuitry of FIG. 1 may be instantiated, for example, in one or more threads executing concurrently and/or in series. For example, the microprocessor 700 of FIG. 7 may execute machine readable instructions in one or more threads executing concurrently and/or in series. In some examples, the FPGA circuitry 800 of FIG. 8 may be configured and/or structured to carry out operations/functions concurrently and/or in series. Moreover, in some examples, some or all of the circuitry of FIG. 1 may be implemented within one or more virtual machines and/or containers executing on the microprocessor 700 of FIG. 7.

In some examples, the programmable circuitry 612 of FIG. 6 may be in one or more packages. For example, the microprocessor 700 of FIG. 7 and/or the FPGA circuitry 800 of FIG. 8 may be in one or more packages. In some examples, an XPU may be implemented by the programmable circuitry 612 of FIG. 6, which may be in one or more packages. For example, the XPU may include a CPU (e.g., the microprocessor 700 of FIG. 7, the CPU 820 of FIG. 8, etc.) in one package, a DSP (e.g., the DSP 822 of FIG. 8) in another package, a GPU in yet another package, and an FPGA (e.g., the FPGA circuitry 800 of FIG. 8) in still yet another package.

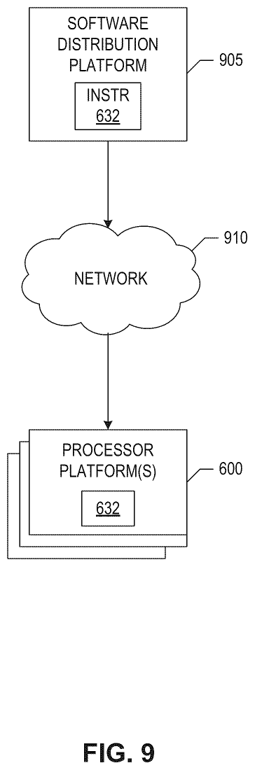

A block diagram illustrating an example software distribution platform 905 to distribute software such as the example machine readable instructions 632 of FIG. 6 to other hardware devices (e.g., hardware devices owned and/or operated by third parties from the owner and/or operator of the software distribution platform) is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine readable instructions 632 of FIG. 6. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine readable instructions 632, which may correspond to the example machine readable instructions of FIGS. 4 and 5, as described above. The one or more servers of the example software distribution platform 905 are in communication with an example network 910, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 632 from the software distribution platform 905. For example, the software, which may correspond to the example machine readable instructions of FIGS. 4 and 5, may be downloaded to the example programmable circuitry platform 600, which is to execute the machine readable instructions 632 to implement the call maintenance circuitry 102 and/or the example avatar controller circuitry 104. In some examples, one or more servers of the software distribution platform 905 periodically offer, transmit, and/or force updates to the software (e.g., the example machine readable instructions 632 of FIG. 6) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that maintain the continuity of video conferencing calls by regenerating (e.g., reconstructing) video conferencing data during low bandwidth and/or intermittent network connection. Disclosed examples can generate an example representation that captures the video conferencing data without losing the valuable information (e.g., words, business context, human emotions, vocal tone, etc.) that was broadcast in the video call. Examples disclosed herein reduce a data burden that a network may otherwise need to satisfy, particularly when network demands are relatively elevated and/or when interference conditions cause an increase in communication error(s). For example, disclosed examples access a transcript of video conferencing data to, in turn, generate a representation of the transcript at a receiver device. In some examples, the transcript may include a file size of 2-3 Kbps. As such, disclosed examples can recover video conferencing data when the network bandwidth limits transmissions to as low as 4 Kbps, for example. Thus, disclosed examples improve the user experience of AV conferencing devices when performance metrics (associated with an example network deteriorate. Further, disclosed examples can cause a video conferencing device to resume live streaming of the video conferencing data when the network bandwidth recovers (e.g., is greater than a threshold value). Disclosed systems, apparatus, articles of manufacture, and methods improve the efficiency of using a computing device by maintaining continuity in video conferencing calls, retaining valuable video conferencing data, etc. Disclosed systems, apparatus, articles of manufacture, and methods are accordingly directed to one or more improvement(s) in the operation of a machine such as a computer or other electronic and/or mechanical device.

Example 1 includes an apparatus comprising interface circuitry, machine-readable instructions, and at least one processor circuit to be programmed by the machine-readable instructions to access input data associated with a first video conferencing device, the first video conferencing device communicatively coupled to a second video conferencing device via a network, generate a representation of the input data when a performance metric corresponding to the network satisfies a threshold value, and transmit the representation to the second video conferencing device via the network.

Example 2 includes the apparatus of example 1, wherein the performance metric includes at least one of a bandwidth value, a latency value, a packet loss value, or a jitter value.

Example 3 includes the apparatus of example 1, wherein one or more of the at least one processor circuit is to transmit the input data to the second video conferencing device when the performance metric satisfies when greater than or equal to the threshold value.

Example 4 includes the apparatus of example 1, wherein the input data corresponds to a first bandwidth value and the representation corresponds to a second bandwidth value, the second bandwidth value less than the first bandwidth value.

Example 5 includes the apparatus of example 1, wherein the input data includes at least one of audio data or video data.

Example 6 includes the apparatus of example 5, wherein one or more of the at least one processor circuit is to prevent the at least one of audio data or video data from transmission via the network when the performance metric satisfies when less than the threshold value.

Example 7 includes the apparatus of example 5, wherein one or more of the at least one processor circuit is to generate a text file based on the at least one of audio data or video data, and generate the representation of the input data based on the text file.

Example 8 includes the apparatus of example 1, wherein one or more of the at least one processor circuit is to generate the representation of the input data as instructions corresponding to an avatar representation stored on the second video conferencing device.

Example 9 includes the apparatus of example 8, wherein the avatar representation corresponds to a user of the first video conferencing device.

Example 10 includes At least one non-transitory machine-readable medium comprising machine-readable instructions to cause at least one processor circuit to at least access input data associated with a first video conferencing device, the first video conferencing device communicatively coupled to a second video conferencing device via a network, generate a representation of the input data when a performance metric corresponding to the network is less than a threshold value, and transmit the representation to the second video conferencing device via the network.

Example 11 includes the at least one non-transitory machine-readable medium of example 10, wherein the performance metric includes a bandwidth value.

Example 12 includes the at least one non-transitory machine-readable medium of example 10, wherein the machine-readable instructions are to cause one or more of the at least one processor circuit to transmit the input data to the second video conferencing device when the performance metric is greater than the threshold value.

Example 13 includes the at least one non-transitory machine-readable medium of example 10, wherein the input data corresponds to a first bandwidth value and the representation corresponds to a second bandwidth value, the second bandwidth value less than the first bandwidth value.

Example 14 includes the at least one non-transitory machine-readable medium of example 10, wherein the input data includes at least one of audio data or video data.

Example 15 includes the at least one non-transitory machine-readable medium of example 14, wherein the machine-readable instructions are to cause one or more of the at least one processor circuit to prevent the at least one of audio data or video data from transmission via the network when the performance metric is less than the threshold value.

Example 16 includes the at least one non-transitory machine-readable medium of example 14, wherein the machine-readable instructions are to cause one or more of the at least one processor circuit to generate a text file based on the at least one of audio data or video data, and generate the representation of the input data based on the text file.

Example 17 includes the at least one non-transitory machine-readable medium of example 10, wherein the machine-readable instructions are to cause one or more of the at least one processor circuit to generate the representation of the input data as instructions corresponding to an avatar representation stored on the second video conferencing device.

Example 18 includes the at least one non-transitory machine-readable medium of example 17, wherein the avatar representation corresponds to a user of the first video conferencing device.

Example 19 includes an apparatus comprising means for accessing input data associated with a first video conferencing device, the first video conferencing device communicatively coupled to a second video conferencing device via a network, means for generating a representation of the input data when a performance metric corresponding to the network is less than a threshold value, and means for transmitting the representation to the second video conferencing device via the network.

Example 20 includes the apparatus of example 19, wherein the performance metric includes a bandwidth value.

Example 21 includes the apparatus of example 19, wherein the means for transmitting is to transmit the input data to the second video conferencing device when the performance metric is greater than the threshold value.

Example 22 includes the apparatus of example 19, wherein the input data corresponds to a first bandwidth value and the representation corresponds to a second bandwidth value, the second bandwidth value less than the first bandwidth value.

Example 23 includes the apparatus of example 19, wherein the input data includes at least one of audio data or video data.

Example 24 includes the apparatus of example 23, wherein the means for transmitting is to prevent the at least one of audio data or video data from transmission via the network when the performance metric is less than the threshold value.

Example 25 includes the apparatus of example 23, wherein the means for generating is first means for generating, further including second means for generating a text file based on the at least one of audio data or video data, and the first means for generating to generate the representation of the input data based on the text file.

Example 26 includes the apparatus of example 19, wherein the means for generating is to generate the representation of the input data as instructions corresponding to an avatar representation stored on the second video conferencing device.

Example 27 includes the apparatus of example 26, wherein the avatar representation corresponds to a user of the first video conferencing device.

Example 28 includes an apparatus comprising interface circuitry, first machine-readable instructions, and at least one processor circuit to be programmed by the first machine-readable instructions to compare a performance metric associated with a network to a threshold value, the network communicatively coupled to a first video conferencing device and a second video conferencing device, the first video conferencing device to transmit input data to the second video conferencing device via the network, when the performance metric is less than the threshold value, cause second machine-readable instructions to configure a proxy of the input data, the second machine-readable instructions instantiated by the first video conferencing device, and cause display of the proxy on a user interface of the second video conferencing device.

Example 29 includes the apparatus of example 28, wherein the input data includes at least one of audio data or video data.

Example 30 includes the apparatus of example 28, wherein one or more of the at least one processor circuit is to generate the proxy of the input data based on the second machine-readable instructions.

Example 31 includes the apparatus of example 30, wherein one or more of the at least one processor circuit is to configure the proxy by accessing an avatar representation of a user of the first video conferencing device, the avatar representation stored in a database associated with the second video conferencing device, and configuring the avatar representation to simulate the second machine-readable instructions.

Example 32 includes At least one non-transitory machine-readable medium comprising first machine-readable instructions to cause at least one processor circuit to at least compare a performance metric associated with a network to a threshold value, the network communicatively coupled to a first video conferencing device and a second video conferencing device, the first video conferencing device to transmit input data to the second video conferencing device via the network, when the performance metric is less than the threshold value, cause second machine-readable instructions to configure a proxy of the input data, the second machine-readable instructions instantiated by the first video conferencing device, and cause display of the proxy on a user interface of the second video conferencing device.

Example 33 includes the at least one non-transitory machine-readable medium of example 32, wherein the input data includes at least one of audio data or video data.

Example 34 includes the at least one non-transitory machine-readable medium of example 32, wherein the first machine-readable instructions are to cause one or more of the at least one processor circuit to generate the proxy of the input data based on the second machine-readable instructions.

Example 35 includes the at least one non-transitory machine-readable medium of example 34, wherein the first machine-readable instructions are to cause one or more of the at least one processor circuit to configure the proxy by accessing an avatar representation of a user of the first video conferencing device, the avatar representation stored in a database associated with the second video conferencing device, and configuring the avatar representation to simulate the second machine-readable instructions.

Example 36 includes an apparatus comprising means for comparing a performance metric associated with a network to a threshold value, the network communicatively coupled to a first video conferencing device and a second video conferencing device, the first video conferencing device to transmit input data to the second video conferencing device via the network, when the performance metric is less than the threshold value, means for accessing to cause machine-readable instructions to configure a proxy of the input data, the machine-readable instructions instantiated by the first video conferencing device, and means for displaying to cause display of the proxy on a user interface of the second video conferencing device.

Example 37 includes the apparatus of example 36, wherein the input data includes at least one of audio data or video data.

Example 38 includes the apparatus of example 36, further including means for encoding to generate the proxy of the input data based on the machine-readable instructions.

Example 39 includes the apparatus of example 38, further including means for configuring to access an avatar representation of a user of the first video conferencing device, the avatar representation stored in a database associated with the second video conferencing device, and configure the avatar representation to simulate the machine-readable instructions.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus comprising:
interface circuitry;
machine-readable instructions; and
at least one processor circuit to be programmed by the machine-readable instructions to:
access input data associated with a first video conferencing device, the first video conferencing device communicatively coupled to a second video conferencing device via a network;
generate a representation of the input data when a performance metric corresponding to the network satisfies a threshold value; and
transmit the representation to the second video conferencing device via the network.

2. The apparatus of claim 1, wherein the performance metric includes at least one of a bandwidth value, a latency value, a packet loss value, or a jitter value.

3. The apparatus of claim 1, wherein one or more of the at least one processor circuit is to transmit the input data to the second video conferencing device when the performance metric satisfies when greater than or equal to the threshold value.

4. The apparatus of claim 1, wherein the input data corresponds to a first bandwidth value and the representation corresponds to a second bandwidth value, the second bandwidth value less than the first bandwidth value.

5. The apparatus of claim 1, wherein the input data includes at least one of audio data or video data.

6. The apparatus of claim 5, wherein one or more of the at least one processor circuit is to prevent the at least one of audio data or video data from transmission via the network when the performance metric satisfies when less than the threshold value.

7. The apparatus of claim 5, wherein one or more of the at least one processor circuit is to:
generate a text file based on the at least one of audio data or video data; and
generate the representation of the input data based on the text file.

8. The apparatus of claim 1, wherein one or more of the at least one processor circuit is to generate the representation of the input data as instructions corresponding to an avatar representation stored on the second video conferencing device.

9. The apparatus of claim 8, wherein the avatar representation corresponds to a user of the first video conferencing device.

10. At least one non-transitory machine-readable medium comprising machine-readable instructions to cause at least one processor circuit to at least:
access input data associated with a first video conferencing device, the first video conferencing device communicatively coupled to a second video conferencing device via a network;
generate a representation of the input data when a performance metric corresponding to the network is less than a threshold value; and
transmit the representation to the second video conferencing device via the network.

11. The at least one non-transitory machine-readable medium of claim 10, wherein the performance metric includes a bandwidth value.

12. The at least one non-transitory machine-readable medium of claim 10, wherein the machine-readable instructions are to cause one or more of the at least one processor circuit to transmit the input data to the second video conferencing device when the performance metric is greater than the threshold value.

13. The at least one non-transitory machine-readable medium of claim 10, wherein the input data corresponds to a first bandwidth value and the representation corresponds to a second bandwidth value, the second bandwidth value less than the first bandwidth value.

14. The at least one non-transitory machine-readable medium of claim 10, wherein the input data includes at least one of audio data or video data.

15. The at least one non-transitory machine-readable medium of claim 14, wherein the machine-readable instructions are to cause one or more of the at least one processor circuit to prevent the at least one of audio data or video data from transmission via the network when the performance metric is less than the threshold value.

16. The at least one non-transitory machine-readable medium of claim 14, wherein the machine-readable instructions are to cause one or more of the at least one processor circuit to:
generate a text file based on the at least one of audio data or video data; and
generate the representation of the input data based on the text file.

17. The at least one non-transitory machine-readable medium of claim 10, wherein the machine-readable instructions are to cause one or more of the at least one processor circuit to generate the representation of the input data as instructions corresponding to an avatar representation stored on the second video conferencing device.

18. The at least one non-transitory machine-readable medium of claim 17, wherein the avatar representation corresponds to a user of the first video conferencing device.

19. An apparatus comprising:
means for accessing input data associated with a first video conferencing device, the first video conferencing device communicatively coupled to a second video conferencing device via a network;
means for generating a representation of the input data when a performance metric corresponding to the network is less than a threshold value; and
means for transmitting the representation to the second video conferencing device via the network.

20. The apparatus of claim 19, wherein the performance metric includes a bandwidth value.

21.-39. (canceled)
